(19) United States
(12) Patent Application Publication
(10) Pub. No.: US 2008/0146814 A1
(43) Pub. Date: Jun. 19, 2008

(54) Process for producing N-protected boryl compounds

(75) Inventors: Milton R. Smith, East Lansing, MI (US); Robert E. Maleczka, DeWitt, MI (US); Venkata A. Kallepalli, East Lansing, MI (US); Edith Onyeozili, Tallahassee, FL (US)

Correspondence Address: Ian C. McLeod;IAN C. McLEOD, P.C., 2190 Commons Parkway, Okemos, MI, 48864, US

(73) Assignee: Board of Trustees of Michigan State University, Lansing, MI (US)

(21) Appl. No.: 11/900,303

(22) Filed: Sep. 11, 2007

Related U.S. Application Data
(60) Provisional application No. 60/843,589, filed on Sep. 11, 2006.

(51) Int. Cl. C07F 5/02

(52) U.S. Cl. 548/110; 548/405

(57) ABSTRACT

Process for the preparation of N-protected boryl compounds. The compounds are intermediates to functionalized compounds, both natural and synthetic which are cytotoxic, anticancer and antiviral agents.

### CROSS-REFERENCE TO RELATED APPLICATIONS

This application claims benefit to U.S. Provisional Application Ser. No. 60/843,589, filed Sep. 11, 2006, which is incorporated herein by reference in its entirety.

### STATEMENT REGARDING FEDERALLY SPONSORED RESEARCH OR DEVELOPMENT

This work was supported by a grant from the National Institute of Health (NIH)— Grant No. GM063188. The U.S. government has certain rights to this invention.

### BACKGROUND OF THE INVENTION

(1) Field of the Invention

The present invention relates to the preparation of boryl compounds with an N-protected nitrogen, using iridium complexes. The present invention also relates to novel compounds.

(2) Description of the Related Art

Compounds with a nitrogen substituent are important as cytotoxic, anticancer and antiviral agents. Compounds with N—H bonds are pervasive, occurring in peptides and other compounds with biological activity. In the synthesis of complex molecules containing heteroatom-hydrogen bonds, it is often critical to be able to selectively protect and deprotect these reactive entities to devise high yielding syntheses.^{a} Typically, protection involves replacing reactive hydrogens with more robust groups, while deprotection involves cleaving the robust group, replacing it with hydrogen.

Protecting groups for N—H bonds are numerous. Of these protecting groups, alkoxycarbonyl groups have preferred status. These groups are utilized in amino acid synthesis, where high-yielding protection/deprotection sequences are absolutely critical for obtaining useful quantities of material. Alkoxycarbonyl groups are also frequently employed for the protection of N—H groups where the nitrogen is part of a cyclic structure. Thus, compatibility with nitrogen protecting groups, due to their ubiquity in pharmaceutical synthetic strategies, is a key criterion in assessing the scope of a chemical process

U.S. Patent Application No. 2005/0148775 μl Miyaura et al. describes the preparation of heterocyclic boryl compounds. The use of an easily removable N-protecting group is not described.

### OBJECTS

It is an object of the present invention to provide a process for the preparation of boryl substituted compounds bearing protected nitrogen groups as intermediates to compounds with cytotoxic, anticancer, and antiviral activities.

These and other objects will become increasingly apparent by reference to the following description and drawings.

### SUMMARY OF THE INVENTION

The present invention provides a process for producing N-substituted boryl compounds (I-III) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two,

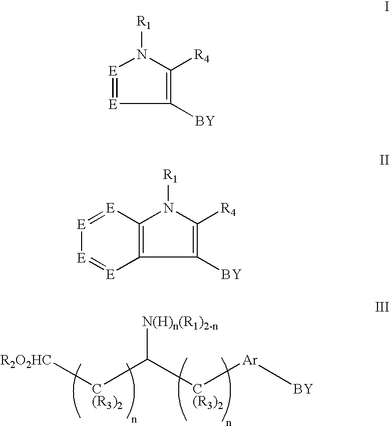

which comprises: reacting N-protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group and the boryl group is derived from HBPin or B₂Pin, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two,

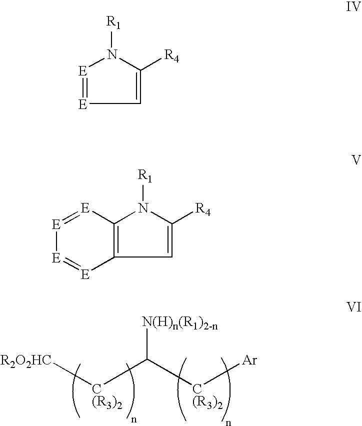

in a reaction mixture with a non-reactive solvent selected from, but not limited to, aliphatic hydrocarbons and ethers at temperatures between about 0 and 150° C. with an HB or B—B organic compound, in the presence of a catalytically effective amount of an iridium complex catalytic composition comprising an iridium complex of the formula: (BY)ₙ—Ir-(ligand)ₘ where n is equal to one to five and m is equal to one to three, excluding hydrogen, bonded to the iridium BY is a boron moiety and the ligand is selected from the group consisting of a phosphorus organic ligand, an organic amine, an imine, a nitrogen heterocycle, and an ether wherein the ligand is at least in part bonded to the iridium, to form the compounds (I-III) in the reaction mixture; and evaporating the solvent and portions of the reaction mixture which are volatile from the reaction mixture to produce the compound (I-III).

The present invention provides an N-substituted boryl compound (I-III) selected from the group consisting of indole, azaindole, phenyl alanine, aryl amino acids, tryptophan, thiophene amino acids, heteroatom aromatic amino acids, pyrrole, and azole wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two.

The present invention provides a process for producing a N-tert-butoxycarbonyl substituted protected boryl compound (I-III), wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two, which comprises: reacting an N-tert-butoxycarbonyl protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two, with an HB or B—B organic compound in a reaction mixture with a non-reactive first solvent selected from, but not limited to, aliphatic hydrocarbons and ethers at elevated temperatures between about 0 and 150° C. in the presence of a catalytically effective amount of an iridium complex catalytic composition comprising an iridium complex of the formula: (BY)ₙ—Ir-(ligand)ₘ where n is equal to one to five and m is equal to one to three, excluding hydrogen, bonded to the iridium, wherein BY is a boron moiety and the ligand is selected from the group consisting of a phosphorus organic ligand, an organic amine, an imine, a nitrogen heterocycle, and an ether wherein the ligand is at least in part bonded to the iridium, in a molar ratio of complex to ligand between 1 to 3 and 1 to 1, wherein the ligand is at least in part bonded to the iridium, to form compounds (I-III); evaporating the first solvent and portions of the reaction mixture which are volatile from the reaction mixture; dissolving the compound (I-III) in a second solvent; and isolating the compound (I-III) from the second solvent.

The present invention provides an N-tert-butoxycarbonyl substituted boryl compound (I-III) selected from the group consisting of indole, azaindole, phenyl alanine, aryl amino acids, tryptophan, thiophene amino acids, heteroatom aromatic amino acids, pyrrole, and azole wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two.

The present invention provides a process for producing a N-tert-butoxycarbonyl substituted protected boryl compound (I-III), wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two, which comprises: reacting an N-tert-butoxycarbonyl protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two, with an HB or B—B organic compound in a reaction mixture with a non-reactive first solvent selected from, but not limited to, aliphatic hydrocarbons and ethers at elevated temperatures between about 0 and 150° C. in the presence of a catalytically effective amount of an iridium complex catalytic composition comprising an iridium complex of the formula: (BY)ₙ—Ir-(ligand)ₘ where n is equal to one to five and m is equal to one to three, excluding hydrogen, bonded to the iridium, wherein BY is a boron moiety and the ligand is selected from the group consisting of a phosphorus organic ligand, an organic amine, an imine, a nitrogen heterocycle, and an ether wherein the ligand is at least in part bonded to the iridium, in a molar ratio of complex to ligand between 1 to 3 and 1 to 1, wherein the ligand is at least in part bonded to the iridium, to form compounds (I-III); and evaporating the solvent and portions of the reaction mixture which are volatile from the reaction mixture to produce the compound (I-III).

The present invention provides a process for producing boryl compounds (VII-IX) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two,

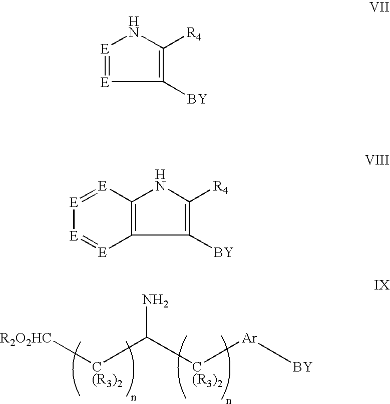

which comprises heating at temperatures between 180 and 200° C. in air an N-tert-butoxycarbonyl substituted compound (I-III) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two.

A process for producing N-substituted compounds (X-XII) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two, wherein R₅ is each selected from the group consisting of alkyl, aryl, heteroaryl, cycloalkyl, and N—, S—, and O-containing groups,

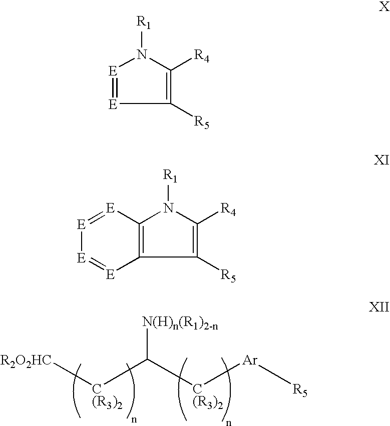

which comprises: reacting N-protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group and the boryl group is derived from HBPin or B₂Pin, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two,

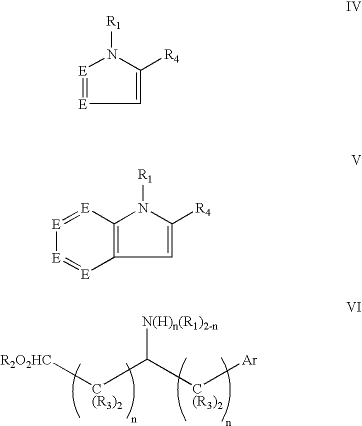

in a reaction mixture with a non-reactive solvent selected from, but not limited to, aliphatic hydrocarbons and ethers at temperatures between about 0 and 150° C. with an HB or B—B organic compound, in the presence of a catalytically effective amount of an iridium complex catalytic composition comprising an iridium complex of the formula: (BY)ₙ—Ir-(ligand)ₘ where n is equal to one to five and m is equal to one to three, excluding hydrogen, bonded to the iridium BY is a boron moiety and the ligand is selected from the group consisting of a phosphorus organic ligand, an organic amine, an imine, a nitrogen heterocycle, and an ether wherein the ligand is at least in part bonded to the iridium, to form the compounds (I-III) in the reaction mixture; evaporating the solvent and portions of the reaction mixture which are volatile from the reaction mixture to produce the compound (I-III); reacting in the same reaction vessel without purification the N-substituted boryl compound (I-III) with an alkyl, aryl, heteroaryl, or cycloalkyl halide or triflate, an amine, thiol, or alcohol in the presence of suitable bases and palladium or copper catalysts known to promote substitutions of boryl groups; and evaporating the solvent and portions of the reaction mixture which are volatile from the reaction mixture to produce the compound (X-XII). In further embodiments, R₁ is tert-butoxycarbonyl. In still further embodiments, the complex is an iridium complex of [Ir(OMe)(COD)]₂, [Ir(Cl)(COD)]₂, or (COD) (η⁵-indenyl)Ir, where COD is 1,5-cyclooctadine, complexed with a ligand selected from the group consisting of:

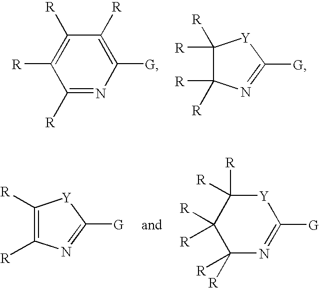

wherein R are each selected from the group consisting of hydrogen, linear alkyl containing 1 to 8 carbon atoms, branched alkyl containing 1 to 8 carbons, and a carbon in a cyclic structure, Y is a carbon, oxygen, nitrogen, or sulfur containing moiety, and G is a heteroatom containing group, multiple atom chain, or multiple atom ring. In further still embodiments, the complex is an iridium complex of [Ir(OMe)(COD)]₂, [Ir(Cl)(COD)]₂, or (COD) (η⁵-indenyl)Ir, where COD is 1,5-cyclooctadine, complexed with a ligand selected from the group consisting of:

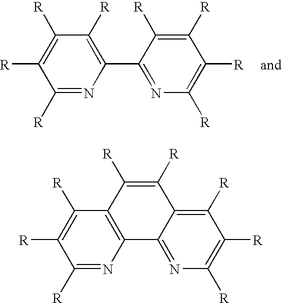

wherein R are each selected from the group consisting of hydrogen, linear alkyl containing 1 to 8 carbon atoms, branched alkyl containing 1 to 8 carbons, and a carbon in a cyclic structure. In still further embodiments, the complex is an iridium complex of [Ir(OMe)(COD)]₂, [Ir(Cl)(COD)]₂, or (COD) (η⁵-indenyl)Ir, where COD is 1,5-cyclooctadine, complexed with a ligand selected from the group consisting of:

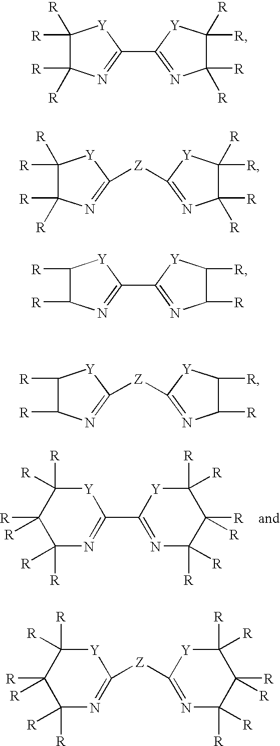

wherein R are each selected from the group consisting of hydrogen, linear alkyl containing 1 to 8 carbon atoms, branched alkyl containing 1 to 8 carbons, and a carbon in a cyclic structure, Y is a carbon, oxygen, nitrogen, or sulfur containing moiety, and Z is a carbon, oxygen, nitrogen, sulfur, or boron containing moiety or a multiple atom chain containing a carbon, oxygen, nitrogen, sulfur, or boron containing moiety. In still further embodiments, the complex is an iridium complex of [Ir(OMe)(COD)]₂, [Ir(Cl)(COD)]₂, or (COD) (η⁵-indenyl)Ir, where COD is 1,5-cyclooctadine, complexed with a ligand selected from the group consisting of:

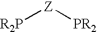

wherein R are each selected from the group consisting of hydrogen, aryl, linear alkyl containing 1 to 8 carbon atoms, branched alkyl containing 1 to 8 carbons, alkoxy, or a carbon in a cyclic structure and Z is a carbon, oxygen, or nitrogen containing moiety or a multiple atom chain containing a carbon, oxygen, or nitrogen containing moiety. In further still embodiments, the HB or B—B organic compound is HBPin or B₂Pin₂. In still further embodiments, the complex is an iridium complex of [Ir(OMe)(COD)]₂, [Ir(Cl)(COD)]₂, or (COD) (η⁵-indenyl)Ir, where COD is 1,5-cyclooctadine, complexed with 4,4-di-t-butyl-2,2′bipyridine (dtbpy). In still further embodiments, the complex is an iridium complex of [Ir(OMe)(COD)]₂, [Ir(Cl)(COD)]₂, or (COD) (η⁵-indenyl)Ir, where COD is 1,5-cyclooctadine, complexed with 1,2-bis(dimethylphospino)ethane.

### DETAILED DESCRIPTION OF THE INVENTION

All patents, patent applications, government publications, government regulations, and literature references cited in this specification are hereby incorporated herein by reference in their entirety. In case of conflict, the present description, including definitions, will control.

Ir-catalyzed borylation of C—H bonds is emerging as a method for functionalizing aromatic and heteroaromatic hydrocarbons.^{b} For aromatic substrates, steric effects dictate the regioselectivity, giving access to regiochemistry that is difficult to obtain using traditional synthetic methods. While for heterocyclic substrates, the origins of regioselectivity are less apparent, it has been shown that (i) borylation of C—H bonds flanked by an sp²-hybridized nitrogen like that in pyridine are difficult,^{2f,l} and (ii) borylation in pyrroles, indoles, furans, and thiophenes occurs adjacent to the heteroatom (Scheme 1).²f-i,l,p

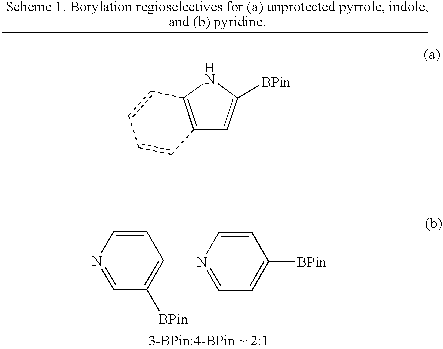

We have previously shown that the borylation regiochemistry in pyrrole can be altered when the nitrogen group is protected with a trialkyl silane.^{c} Trimethylsilyl protection was impractical as the N—Si bond in N-trimethylsilyl pyrrole is prone to hydrolysis. Hence, the more hindered (and more expensive) triisopropysilyl (TIPS) group was required to obtain reasonable yields of isolated product.

tert-butoxycarbonyl-protected N-heterocycles. Of the many available nitrogen protecting groups, the tert-butoxycarbonyl (Boc) group is widely used to protect N—H bonds.^{d} Given that Ir-catalyzed borylation tolerates amide functionality, we questioned whether N-Boc protected substrates would be compatible with borylations, providing a more economical and versatile means for altering the borylation regioselectivity of pyrroles and related substrates.^{e} Also, Boc compatibility could facilitate functionalizations of natural and unnatural aromatic amino acids.

Table 1 shows the results for borylations of Boc-protected nitrogen heterocycles. For example, N-Boc pyrrole reacts smoothly with effectively complete regioselectivity for the 3-position (Table 1, entry 1) in excellent yield at an Ir catalyst loading of 0.5 mol %. The yields are reproducible and scalable with the largest scale to date utilizing 100 g of the pyrrole and 1.25 equiv of pinacolborane (HBPin).

TABLE 1
Borylation of N-Boc protected heterocycles.^{a}

| | | HBPin equiv. | | |
|---|---|---|---|---|
| | | Solvent. Time. | | |
| | | Reaction Temp. | | |
| Entry | Substrate | Ir Loading | Product | % Yield^{b} |
| 1 | 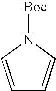 | 1.3 equiv THF.13 h. 55° C.0.5 mol % | 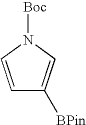 | 90 |
| 2 | 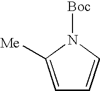 | 1.5 equiv.THF. 5 h. 60° C.3 mol % | 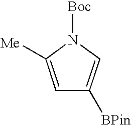 | 82 |
| 3 | 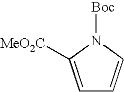 | 1.2 equiv.n-hexane. 5 h.room temp..3 mol % | 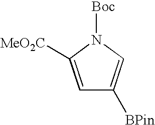 | 75 |
| 4 | 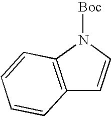 | 2 equiv.n-hexane. 5 h.60° C. 3 mol % | 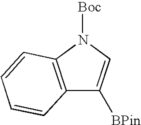 | 65 |
| 5 | 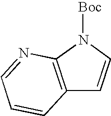 | 1.1 equiv.n-hexane. 5 h.room temp..3 mol % | 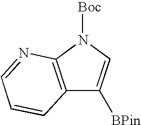 | 56 |
| 6^{c} | 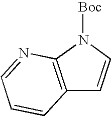 | 3.5t equiv.n-hexane. 96 h.room temp..6 mol % | 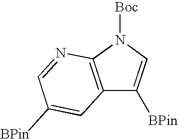 | 54 |
| 7^{c} | 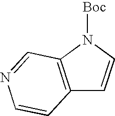 | 1.3 equiv THF.20 h. 55° C.6 mol % | 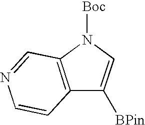 | 14 |
| 8^{c,d} | 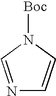 | — | 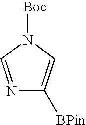 | 0 |

^{a}See supporting information for specific reaction conditions.
^{b}Isolated yield based upon an average of two runs.
^{c}dppe was used in borylation step.
^{d}Small amounts of aminated biphenyls were detected.

N-Boc compatibility is reasonably general as indicated the other entries in Table 1. In addition to substituted pyrrole entries 2 and 3, N-Boc-indole (entry 4) and N-Boc 7-azaindole (entry 5) afford acceptable yields of 3-borylated products. The outcome for N-Boc-7-azaindole reflects a preference for the 3-position of a 5-membered nitrogen heterocycle over sterically accessible sites in the 6-memebered N-heterocyclic moiety. Consistent with the regiochemical preferences in Scheme 1, a second borylation of N-Boc-7-azaindole proceeds selectively at the 5-position, presumably because C5 is less hindered than C4.

The yield for N-Boc-6-azaindole is disappointingly low. The reason for this is unclear; however, the 6-N likely inhibits catalysis by coordinating to Ir. Gas evolution was evident when HBPin was added to N-Boc-imidazole. In this case N-3 may be sufficiently nucleophilic to coordinated to the borane, yielding an activated hydride that effects deprotection. This problem can be overcome by employing more robust protecting groups like N,N-dimethylaminosulfonyl.

Boc-protected amino acids. N-Boc amino acids were a second important class of Boc-protected compounds for consideration. The demonstrated compatibility of primary amides with borylation conditions augured favorably for success on this front. As indicated in Table 2, N-Boc aromatic and heteroaromatic amino acids are suitable substrates. The regioselectivities are substrate dependent largely following the patterns established for arenes and heterocycles. For example, N-Boc phenylalanine yields a 71:29 mixture of meta and para borylated products when borylation is carried to 40% conversion (Table 2, entry 1). Higher conversions to monoborylated materials could not be achieved as diborylation depleted the meta isomer. The reaction with 2 equiv of B₂Pin₂ affords the 3,5-diborylated product as a single isomer, albeit in low yield. Reactivity was generally lower for the Boc-protected amines and B₂Pin₂ was used as the borylating agent to improve efficiency.

TABLE 2
Borylation of N-Boc protected amino acids.^{a}

| | | borylating agent | | |
|---|---|---|---|---|
| | | (equiv). solvent. | | |
| | | time. temp. | | |
| entry | substrate | catalyst loading | product | % yield |
| 1 | 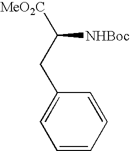 | 1.0 equiv B₂Pin₂.CyH. 30 min.120° C.3 mol % Ir | 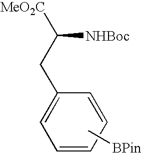 | 26^{b}(m:p -71:29) |
| 2 | 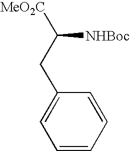 | 1.0 equiv B₂Pin₂.CyH. 1 h.120° C.3 mol % Ir | 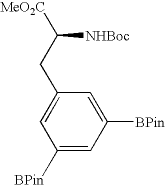 | 18 |
| 3 | 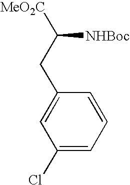 | 1.2 equiv B₂Pin₂.CyH. 10 min.120° C.3 mol % Ir | 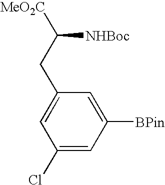 | 80 |
| 4 | 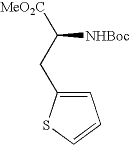 | 1.1 B₂Pin₂.THF. 5 h. 60° C.3 mol % Ir | 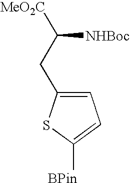 | 79 |
| 5 | 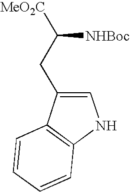 | 0.2 equiv HBPin.1.0 equiv B₂Pin₂.MTBE. rt.45 min | 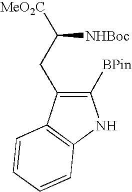 | 43 (63)^{c} |
| 6 | 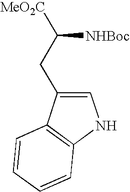 | 0.3 equiv HBPin.2.0 equiv B₂Pin₂.MTBE. rt. 19 h | 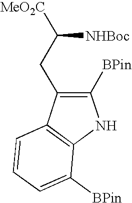 | 54 |

^{a}Reactions were typically carried out with 3 mol % Ir loadings relative to the number of C—H bonds to be borylated. The active catalyst was generated in situ by adding HBPin to [Ir(OMe)(COD)]₂, followed by addition of dtbpy. The catalyst solution was added to a solution of B₂Pin₂ and the substrate. See supporting information for specific reaction conditions.
^{b}40% conversion of the protected amino acid.

When the aromatic or heteroaromatic substituent has a predilection for regioselective borylation, conversion and isolated yields improve dramatically as illustrated for protected 3-chlorophenylalanine and 2-thiophenylalanine (entries 3 and 4). The final two entries in Table 2 show the indole nucleus of protected tryptophan can be mono or diborylated. The conversions for the tryptophan substrate were not as good as for the other amino acids in Table 2. The reasons for this are not obvious. Indoles are excellent substrates for aromatic borylation, and the amino acid protecting groups behave perfectly well for the borylations in entries 3 and 4. Preparation of the monoborylated compound (entry 5) was complicated by competing diborylation. Nevertheless, the monoborylated compound could be separated from the diborylated product and unreacted tryptophan substrate. By comparison, preparation of the diborylated compound was straightforward as long as triborylation was avoided. Both d and l isomers of N-Boc tryptophan methyl ester were diborylated separately to test for racemization of the chiral center. In each case, chiral HPLC analysis showed none of the enantiomer. These preliminary results are encouraging for applications of Ir-catalyzed borylations in peptide functionalization.

One-pot borylation/C—C cross coupling. We, and others, have developed one-pot processes where Ir-catalyzed borylations are followed by one or more chemical transformations. For the present purposes, the discussion will be restricted to one-pot borylation/C—C cross-coupling of N-Boc pyrrole.^{f}

For the Pd-catalyzed cross-coupling, we employed the catalyst and conditions recently disclosed by Buchwald and Billingsley.^{g} In addition, we chose 3-chlorothiophene as the coupling partner, because its coupling with boronate 1 was one of the plethora they reported. The reaction was carried out with the borylation conditions in Scheme 2. The Pd catalyzed coupling was initially carried out as part of a one-pot sequence, where the crude borylation reaction mixture was subjected cross-coupled with the chlorothiophene under the conditions described by Buchwald and Billingsley. Compared to other one-pot reactions that we've performed, the 21% yield of biheterocycle 2 (Table 3, entry 1) was disappointingly low considering that a 51% yield was reported for the Pd-catalyzed coupling of 3-chlorothiophene and 1. To determine whether the Ir catalyst residue might be interfering, we attempted cross-coupling with isolated 1 (entry 2). Surprisingly, we obtained the coupled product in 85% isolated yield, a significant increase over the reported yield.

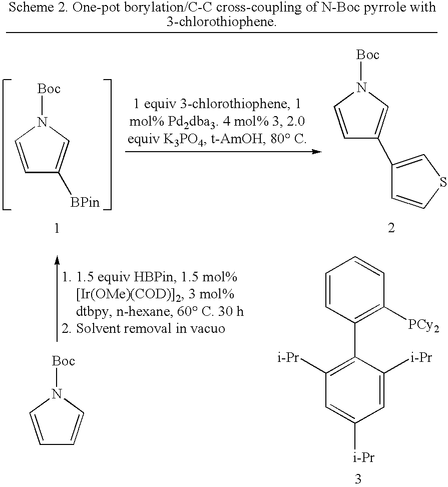

TABLE 3
Comparisons between routes to 2.^{a}

| | | Cross-coupling | |
|---|---|---|---|
| Entry | Starting Material | conditions | Isolated Yield of 2 |
| 1 | N-Boc-pyrrole | Scheme 2, 12 h | 21%^{b} |
| 2 | 1 | Scheme 2, 12 h | 85% |
| 3 | N-Boc-pyrrole | Scheme 2, 30 h | 76% |

^{a}See supporting information for specific reaction conditions.
^{b1}H NMR analysis of the reaction mixture revealed that 1 was the major pyrrole species.

Clearly, something in the catalytic milieu interferes with the one-pot reaction. We consider it likely that the Ir catalyst competes with Pd for phosphine 3, thereby reducing the concentration of the active Pd catalyst. Consistent with this notion, we find that the one-pot yield improves with prolonged reaction times, nearly approaching that obtained when the pristine boronate was used. When pyrrole is used as the common starting point, the 76% yield for the one-pot, borylation/C—C coupling route is superior to the 15% yield obtained when the boronate is prepared using conventional methods. The generality for other heterocyclic substrates will be established in future work.

N-Boc deprotection. While it will usually be desirable to remove the Boc group after the boronate ester has been utilized in a cross-coupling or oxidation, there may be advantages to removing the Boc group leaving the C—B bond intact. Numerous methods for Boc deprotection are known to the literature.^{h} We have examined a limited number of these and have found that thermal deprotection gives the best yields of deprotected products for most of the compounds in Table 4.ⁱ It is noteworthy that the deprotection is reproducible only when performed in air.

TABLE 4
Thermal deprotection of N-Boc boronates.^{a}

| entry | substrate | Conditions | product | % yield |
|---|---|---|---|---|
| 1 | 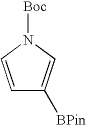 | 180° C. 35 min | 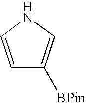 | 80 |
| 2 | 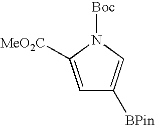 | 180° C. 20 min | 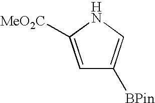 | 76 |
| 3 | 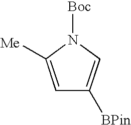 | 140° C. 16 h | 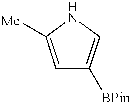 | 72 |
| 4 | 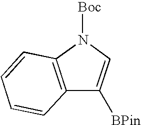 | 180° C. 45 min | 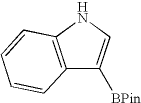 | 64 |

^{a}N-Boc protected substrates were placed in a flask and heated in air until the Boc group was cleaved.

The yields of the deprotected substrates were reasonably good with entry 3 being the most sensitive, ultimately requiring prolonged reaction times at lower temperatures to afford a reasonable yield of the deprotected indole. Significantly, the deprotected products in Table 4 are regioisomers of the products that are obtained by borylating the unprotected heterocycles.

Scheme 3 illustrates how Boc deprotection of boronate esters can be synthetically advantageous. The 3-borylated pyrrole 4 that results when the Boc is removed from the borylation product of N-Boc pyrrole yields the 2,4-diborylated isomer when it is subjected to a second Ir-catalyzed borylation. This complements the chemistry for diborylation of pyrrole, which provides the 2,5-diborylated isomer.

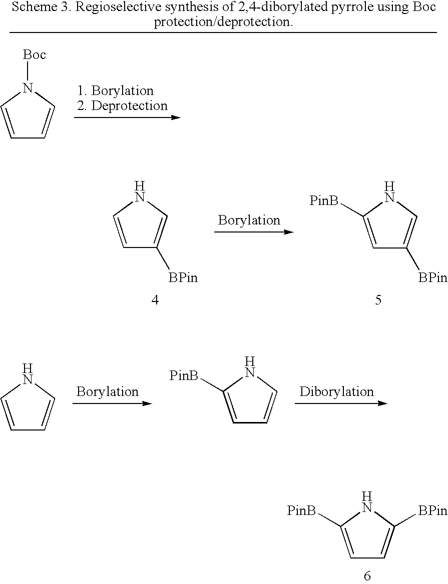

### General Methods:

Pinacolborane (HBPin) was generously supplied by BASF. Bis(η⁴-1,5-cyclooctadiene)-di-p-methoxy-diiridium(I) [Ir(OMe)(COD)]₂ was prepared per the literature procedure.^{j} 4,4′-Di-t-butyl-2,2′-bipyridine (d^{t}bpy) was purchased from Aldrich. N-Boc pyrrole, N-Boc indole and Boc-L-phenylalanine methyl ester were purchased from Aldrich. Methyl-2-pyrrolecarboxylate and 7-azaindole were purchased from Aldrich and Boc-protected per literature procedure.^{k} 2-methylpyrrole and 6-azaindole^{l} were prepared per literature procedure and Boc protected. L-tryptophan was purchased from Chem-Impex International and protected per literature procedure.^{m} All substrates were purified by column chromatography or passing through a plug of alumina. Pinacolborane (HBPin) was distilled before use. n-Hexane was refluxed over sodium, distilled, and degassed. Tetrahydrofuran was obtained from a dry still packed with activated alumina and degassed before use. Silica gel was purchased from EMD™ (230-400 Mesh).

All reactions were monitored by GC-FID (Varian CP-3800; column type: WCOT Fused silica 30 m×0.25 mm ID coating CP-SIL 8 CB). GC-FID method: 70° C., 2 min.; 20° C./min, 9 min.; 250° C., 10 or 20 min.; All reported yields are for isolated materials.

¹H and ¹³C NMR spectra were recorded on a Varian Inova-300 (300.11 and 75.47 MHz respectively), Varian VXR-500 or Varian Unity-500-Plus spectrometer (499.74 and 125.67 MHz respectively) and referenced to residual solvent signals (7.24 ppm and 77.0 ppm for CDCl₃, respectively). ¹¹B spectra were recorded on a Varian VXR-300 operating at 96.29 MHz and were referenced to neat BF₃-Et₂O as the external standard. All coupling constants are apparent J values measured at the indicated field strengths. All 2-dimensional experiments were run using z-axis pulse field gradients. Elemental analyses were performed at Michigan State University using a Perkin Elmer Series II 2400 CHNS/O Analyzer. GC-MS data were obtained using a Varian Saturn 2200 GC/MS (column type: WCOT Fused silica 30 m×0.25 mm ID coating CP-SIL 8 CB). Melting points were measured on a MEL-TEMP® capillary melting apparatus and are uncorrected. Optical rotations were recorded on a Perkin Elmer Polarimeter 341 at the sodium D line. A Biotage Initiator microwave was used for the borylation of Boc-L-phenylalanine (Absorption level: Normal; Stir rate: 600 rpm).

### General Procedure

Unless otherwise specified, all reactions followed this general procedure. The Ir-catalyst was generated by a modified literature protocol,ⁿ where in a glove box, a Schlenk flask, equipped with a magnetic stirring bar, was charged with the corresponding substrate (1 mmol, 1 equiv). Two separate test tubes were charged with [Ir(OMe)(COD)]₂ (10 mg, 0.015 mmol, 3 mol % Ir) and d^{t}bpy (8 mg, 0.03 mmol, 3 mol %). Excess HBPin (1.1 to 2 equiv) was added to the [Ir(OMe)(COD)]₂ containing test tube. n-Hexane or THF (1 mL) was added to the d^{t}bpy containing test tube in order to dissolve the d^{t}bpy. The d^{t}bpy solution was then mixed with the [Ir(OMe)(COD)]₂ and HBPin mixture. After mixing for one minute, the resulting solution was transferred to the Schlenk flask. Additional n-hexane or THF (2×1 mL) was used to wash the test tubes and the washings were transferred to the Schlenk flask. The flask was stoppered, brought out of the glove box, and attached to a Schlenk line in a fume hood. The Schlenk flask was placed under N₂ and the reaction was carried out at the specified temperature. The reaction was monitored by GC FID/MS. After completion of the reaction, the volatile materials were removed on a rotary evaporator. The crude material was purified by column chromatography or dissolved in CH₂Cl₂ and passed through a plug of silica. Small amounts of impurities, if present, were removed by crystallization. Regiochemistry of the borylated products was assigned by NMR spectroscopy (1H, ¹³C, gCOSY, NOE).

Experimental Details and Spectroscopic Data: Table 1, Entry 1: Borylation of N-Boc pyrrole.

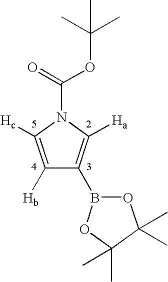

The general procedure was applied to N-Boc pyrrole (1003 mg, 6.00 mmol, 1 equiv) and HBPin (1088 □L, 960 mg, 7.50 mmol, 1.25 equiv) at 55° C. for 13 h. The product was isolated as a white solid (1587 mg, 90% yield, mp 83-85° C.). ¹H NMR (CDCl₃, 500 MHz): δ 7.62-7.61 (t, J=1.7 Hz, 1H, Hₐ), 7.24-7.23 (dd, J=3.2, 2.1 Hz, 1H, H_{c}), 6.45-6.44 (dd, J=3.2, 1.5 Hz, 1H, H_{b}), 1.56 (br s, 9H, CH₃ of ^{t}Bu), 1.30 (br s, 12H, CH₃ of BPin); ¹³C NMR {¹H} (CDCl₃, 125 MHz): δ 148.6 (C═O), 128.8 (CH), 120.7 (CH), 116.2 (CH), 83.8 (C), 83.3 (C), 28.0 (3 CH₃ of ^{t}Bu), 24.8 (4 CH₃ of BPin); ¹¹B NMR (CDCl₃, 96 MHz): δ 30.2; FT-IR (neat) vₘₐₓ: 3150, 2980, 2934, 1748, 1563, 1491, 1372, 1329, 1292, 1217, 1183, 1144, 1067, 976, 936, 857, 775, 691 cm⁻¹; GC-MS (EI) m/z (% relative intensity): M⁺293 (13), 237 (55), 194 (39), 193 (35), 178 (76), 107 (100), 57 (14); Anal. Calcd for C₁₅H₂₄BNO₄: C, 61.45; H, 8.25; N, 4.78. Found: C, 61.68; H, 8.53; N, 4.70.

Table 1, Entry 2: Borylation of N-Boc-2-methylpyrrole.

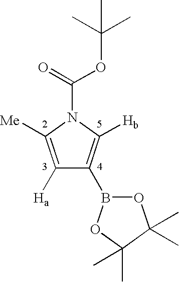

The general procedure was applied to N-Boc-2-methylpyrrole (181 mg, 1.00 mmol, 1 equiv) and HBPin (218 □L, 192 mg, 1.50 mmol, 1.50 equiv) at 60° C. for 6 h. The product was isolated as a white solid (253 mg, 82% yield, mp 68-70° C.). ¹H NMR (CDCl₃, 500 MHz): δ 7.57 (d, J=2.0 Hz, 1H, H_{b}), 6.15-6.14 (m, 1H, Hₐ), 2.39 (d, 1.2 Hz, 3H, CH₃), 1.55 (br s, 9H, CH₃ of ^{t}Bu), 1.29 (br s, 12H, CH₃ of BPin); ¹³C NMR {¹H} (CDCl₃, 125 MHz): δ 149.4 (C═O), 132.5 (C), 129.6 (CH), 115.9 (CH), 83.5 (C), 83.2 (C), 28.0 (3 CH₃ of ^{t}Bu), 24.7 (4 CH₃ of BPin), 15.1 (CH₃); ¹¹B NMR (CDCl₃, 96 MHz): δ 30.2; FT-IR (neat) vₘₐₓ: 2980, 2930, 1748, 1586, 1532, 1399, 1372, 1318, 1296, 1271, 1256, 1221, 1190, 1165, 1144, 1105, 1078, 970, 855, 774, 708, 691 cm⁻¹; GC-MS (EI) m/z (% relative intensity): M⁺307 (23), 251 (100), 207 (48), 192 (37), 121 (49), 57 (13); Anal. Calcd for C₁₆H₂₆BNO₄: C, 62.56; H, 8.53; N, 4.56. Found: C, 62.58; H, 8.46; N, 4.46.

Table 1, Entry 3: Borylation of N-Boc-methyl-2-pyrrolecarboxylate.

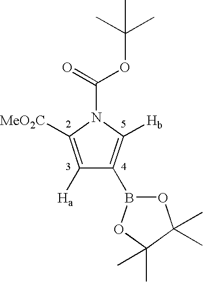

The general procedure was applied to N-Boc-methyl-2-pyrrole carboxylate (450 mg, 2.00 mmol, 1 equiv) and HBPin (348 □L, 307 mg, 2.40 mmol, 1.20 equiv) at room temperature for 5 h. The product was isolated as a white solid (524 mg, 75% yield, mp 109-110° C.). ¹H NMR (CDCl₃, 500 MHz): δ 7.65 (d, J=1.7 Hz, 1H, H_{b}), 7.08 (d, J=1.7 Hz, 1H, Hₐ), 3.79 (s, 3H, CH₃), 1.54 (br s, 9H, CH₃ of ^{t}Bu), 1.27 (br s, 12H, CH₃ of BPin); ¹³C NMR {¹H} (CDCl₃, 125 MHz): δ 161.1 (C═O), 148.0 (C═O), 134.7 (CH), 126.0 (C), 125.6 (CH), 84.9 (C), 83.5 (C), 51.8 (CH₃), 27.6 (3 CH₃ of ^{t}Bu), 24.7 (4 CH₃ of BPin); ¹¹B NMR (CDCl₃, 96 MHz): δ 29.9; FT-IR (neat) vₘₐₓ: 2980, 1755, 1730, 1570, 1483, 1435, 1391, 1373, 1314, 1283, 1252, 1213, 1142, 106, 970, 957, 851, 775, 760, 706, 689 cm⁻¹, GC-MS (EI) m/z (% relative intensity): (M-100)⁺251 (100), 236 (49), 208 (45), 165 (52), 152 (40), 151 (42), 120 (35), 94 (13); Anal. Calcd for C₁₇H₂₆BNO₆: C, 58.14; H, 7.46; N, 3.99. Found: C, 57.84; H, 7.68; N, 3.98.

Table 1, Entry 4: Borylation of N-Boc indole.

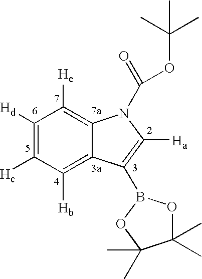

The general procedure was applied to N-Boc indole (1085 mg, 5.00 mmol, 1 equiv) and HBPin (1451 □L, 1280 mg, 10.00 mmol, 2.00 equiv) at 60° C. for 8 h. The product was isolated as a white solid (1113 mg, 65% yield, mp 100-102° C.). ¹H NMR (CDCl₃, 500 MHz): δ 8.16-8.14 (d, J=8.1 Hz, 1H, Hₑ), 8.00 (s, 1H, Hₐ), 7.98-7.96 (m, 1H, H_{b}), 7.31-7.23 (m, 2H, H_{c}, H_{d}), 1.65 (br s, 9H, CH₃ of ^{t}Bu), 1.36 (br s, 12H, CH₃ of BPin); ¹³C NMR {¹H} (CDCl₃, 125 MHz): δ 149.4 (C═O), 136.1 (C), 135.2 (CH), 133.5 (C), 124.2 (CH), 122.9 (CH), 122.6 (CH), 114.9 (CH), 83.8 (C), 83.3 (C), 28.2 (3 CH₃ of ^{t}Bu), 24.9 (4 CH₃ of BPin); ¹¹B NMR (CDCl₃, 96 MHz): δ 30.4; FT-IR (neat) vₘₐₓ: 3054, 2978, 2934, 1740, 1555, 1478, 1453, 1402, 1372, 1339, 1318, 1246, 1208, 1140, 1111, 1061, 986, 857, 766, 748 cm⁻¹; GC-MS (EI) m/z (% relative intensity): (M-100)⁺243 (100), 228 (28), 157 (14), 143 (17); Anal. Calcd for C₁₉H₂₆BNO₄: C, 66.49; H, 7.64; N, 4.08. Found: C, 66.70; H, 7.64; N, 3.95.

Table 1, Entry 5: Borylation of N-Boc-7-azaindole.

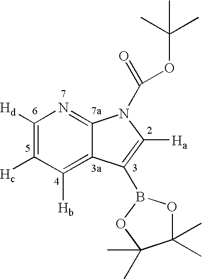

The general procedure was applied to N-Boc-7-azaindole (218 mg, 1.00 mmol, 1 equiv) and HBPin (160 □L, 141 mg, 1.10 mmol, 1.10 equiv) at room temperature for 5 h. The product was isolated as a white solid (193 mg, 56% yield, mp 115-117° C.). ¹H NMR (CDCl₃, 500 MHz): δ 8.46-8.45 (dd, J=4.9, 1.7 Hz, 1H, H_{d}), 8.22-8.20 (dd, J=7.8, 1.7 Hz, 1H, H_{b}), 8.01 (br s, 1H, Hₐ), 7.18-7.16 (dd J=7.8, 4.6 Hz, 1H, H_{c}), 1.62 (br s, 9H, CH₃ of ^{t}Bu), 1.33 (br s, 12H, CH₃ of BPin); ¹³C NMR {¹H} (CDCl₃, 125 MHz): δ 149.3 (C═O), 147.6 (C), 145.1 (CH), 135.4 (CH), 130.9 (CH), 126.1 (C), 118.8 (CH), 84.3 (C), 83.5 (C), 28.1 (3 CH₃ of ^{t}Bu), 24.8 (4 CH₃ of BPin); ¹¹B NMR (CDCl₃, 96 MHz): δ 30.2; FT-IR (neat) vₘₐₓ: 2980, 2934, 1763, 1736, 1599, 1547, 1477, 1418, 1372, 1316, 1285, 1267, 1248, 1211, 1142, 1107, 1069, 984, 858, 775, 681 cm⁻¹; GC-MS (EI) m/z (% relative intensity): (M-100)⁺244 (100), 229 (38), 187 (35), 158 (37), 144 (46) 117 (11); Anal. Calcd for C₁₈H₂₅BN₂O₄: C, 62.81; H, 7.32; N, 8.14. Found: C, 63.18; H, 7.59; N, 8.09.

Table 1, Entry 6: Diborylation of N-Boc-7-azaindole.

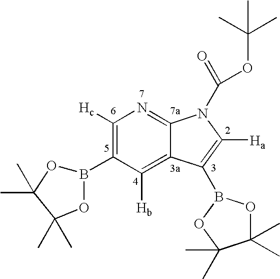

The general procedure was applied to N-Boc-7-azaindole (218 mg, 1.00 mmol, 1 equiv) and HBPin (508 □L, 448 mg, 3.50 mmol, 3.50 equiv) at room temperature for 96 h. The product was isolated as a pale yellow solid (253 mg, 54% yield, mp 176-178° C.). ¹H NMR (CDCl₃, 500 MHz): δ 8.82 (d, J=1.7 Hz, 1H, H_{c}), 8.54 (d, J=1.5 Hz, 1H, H_{b}), 8.01 (s, 1H, Hₑ), 1.63 (br s, 9H, CH₃ of ^{t}Bu), 1.35-1.34 (d, 24H, CH₃ of BPin); ¹³C NMR {¹H} (CDCl₃, 125 MHz): δ 151.5 (CH), 151.1 (C), 147.5 (C), 137.4 (CH), 135.7 (CH), 125.2 (C), 84.3 (C), 83.4 (C), 83.6 (C), 28.1 (3 CH₃ of ^{t}Bu), 24.85 (4 CH₃ of BPin), 24.84 (4 CH₃ of BPin); ¹¹B NMR (CDCl₃, 96 MHz): δ 30.9; FT-IR (neat) vₘₐₓ: 2980, 2934, 1765, 1738, 1543, 1476, 1418, 1372, 1341, 1306, 1246, 1142, 853, 698 cm⁻¹; GC-MS (EI) m/z (% relative intensity): (M-100)⁺370 (100), 355 (13), 313 (10), 285 (45), 271 (14), 171 (10); Anal. Calcd for C₂₄H₃₆B₂N₂O₆: C, 61.31; H, 7.72; N, 5.96. Found: C, 61.55; H, 7.90; N, 6.03.

Table 1, Entry 7: Borylation of N-Boc-6-azaindole.

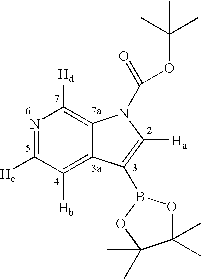

The general procedure was applied to N-Boc-6-azaindole (218 mg, 1.00 mmol, 1 equiv) and HBPin (218 □L, 192 mg, 1.50 mmol, 1.50 equiv) at 55° C. for 20 h (80% conversion). The product was isolated as a white solid (48 mg, 14% yield, mp 114-124° C.). ¹H NMR (CDCl₃, 500 MHz): δ 9.37 (br s, 1H, H_{d}), 8.40-8.39 (d, J=5.4 Hz, 1H, H_{c}), 8.09 (br s, 1H, Hₐ), 7.85-7.84 (dd, J=5.4, 0.7 Hz, 1H, H_{b}), 1.66 (br s, 9H, CH₃ of ^{t}Bu), 1.34 (br s, 12H, CH₃ of BPin); ¹³C NMR {¹H} (CDCl₃, 125 MHz): δ 148.6 (C═O), 142.3 (CH), 139.3 (C), 137.9 (CH), 137.2 (CH), 133.1 (C), 117.1 (CH), 85.1 (C), 83.6 (C), 28.1 (3 CH₃ of ^{t}Bu), 24.9 (4 CH₃ of BPin); ¹¹B NMR (CDCl₃, 96 MHz): δ 30.0; FT-IR (neat) vₘₐₓ: 3137, 2980, 2934, 1746, 1599, 1568, 1545, 1464, 1439, 1400, 1372, 1327, 1310, 1252, 1213, 1138, 1069, 1038, 857, 831, 735 cm⁻¹; GC-MS (EI) m/z (% relative intensity): (M-100)⁺244 (100), 229 (60), 207 (11), 158 (28), 144 (62), 118 (17), 91 (10); Anal. Calcd for C₁₈H₂₅BN₂O₄: C, 62.81; H, 7.32; N, 8.14. Found: C, 63.13; H, 7.72; N, 8.06.

### Preparation of N-methyl-N-(5-(4,4,5,5-tetramethyl-1,3,2-dioxaborolan-2-yl)-1H-imidazol-1-ylthioperoxy)-methanamine

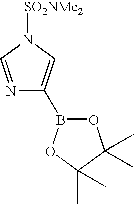

General procedure A was applied to N,N-dimethyl imidazole-1-sulfonamide (175 mg, 1.0 mmol, 1.0 equiv) and B₂ Bpin₂ (254 mg, 1.0 mmol (2.0 mmol B), 1.0 equiv) in ether at room temperature for 65 h. The crude reaction mixture was washed with pentane (3.0 mL portions until the pentane wash is completely colorless) inside the glovebox. The washed product was dried to afford N-methyl-N-(5-(4,4,5,5-tetramethyl-1,3,2-dioxaborolan-2-yl)-1H-imidazol-1-ylthioperoxy)-methanamine (249 mg, 82%) as an off-white solid, 118-122° C. (sublim). ¹H, ¹³C NMR, gHMQC and gHMBC spectroscopy were used to assign the diborylated product as N-methyl-N-(5-(4,4,5,5-tetramethyl-1,3,2-dioxaborolan-2-yl)-1H-imidazol-1-ylthioperoxy)-methanamine ¹H NMR (CDCl₃, 500 MHz): δ 7.97 (s, 1H, Hₐ), 7.66 (s, 1H, H_{b}), 2.83 (s, 6H, N(CH₃)₂), 1.32 (br s, 12H, CH₃ of pinacolate); ¹³C NMR {¹H} (CDCl₃, 75 MHz): δ 137.9, 127.0, 84.2, 38.2, 24.8; ¹¹B NMR (CDCl₃, 96 MHz): δ 29.0; m/e 301 (68), 300 M⁺(24), 286(28), 202(20), 193 (100), 192(28), 149(22), 135 (52), 109(30), 108(42)₉₅(19), 43(25); Anal. Calcd for C₁₁H₂OBN₃O₄S: C, 43.87; H, 6.69; N, 13.95. Found: C, 43.32; H, 6.23; N, 13.73.

Table 2, Entry 1: Borylatibn of Boc-L-phenylalanine methyl ester.

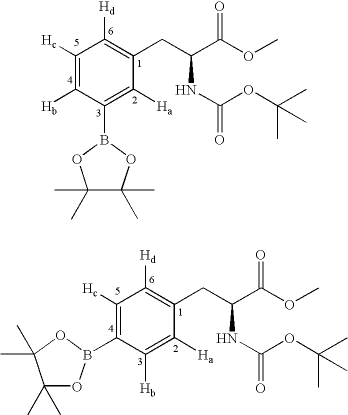

The general procedure was applied to Boc-L-phenylalanine methyl ester (140 mg, 0.50 mmol, 1 equiv) and B₂Pin₂ (127 mg, 0.50 mmol, 1.00 equiv) at 120° C. in a microwave for 0.5 h. There was 37.5% conversion by GC-FID and the ratio of S.M. to meta isomer to para isomer to diborylated product was 62.5:27.0:5.6:4.9 by GC-FID of the crude reaction mixture. Column chromatography (hexanes/diethyl ether 75:25) furnished a mixture of the meta and para isomers as a thick liquid (53 mg, 26% yield) and unreacted starting material (47 mg). The ratio of the two isomers in the isolated product by ¹H NMR was 71:29. gcosy NMR spectroscopy was used to assign the major isomer as meta. ¹H NMR (CDCl₃, 500 MHz): δ (major/meta isomer) 7.66-7.64 (d, J=7.3 Hz, 1H, H_{b}), 7.54 (s, 1H, Hₐ), 7.28-7.25 (t, J=7.5 Hz, 1H, H_{c}), 7.20-7.18 (d, J=7.6 Hz, 1H, H_{d}), 4.98-4.96 (d, J=7.8 Hz, 1H, NH), 4.57-4.51 (m, 1H, CH), 3.68 (s, 3H, CH₃ of Me), 3.13-2.98 (m, 2H, CH₂), 1.38 (br s, 9H, CH₃ of ^{t}Bu), 1.30 (br s, 12H, CH₃ of BPin), (minor/para isomer) 7.71-7.70 (d, J=8.1 Hz, 2H, H), 7.10-7.08 (d, J=7.7 Hz, 2H, H), 4.96-4.95 (d, J=6.6 Hz, 1H, NH), 4.57-4.51 (m, 1H, CH), 3.66 (s, 3H, CH₃ of Me), 3.13-2.98 (m, 2H, CH₂), 1.38 (br s, 9H, CH₃ of ^{t}Bu), 1.30 (br s, 12H, CH₃ of BPin); ¹³C NMR {¹H} (CDCl₃, 125 MHz): 6 (major/meta isomer) 172.3 (C═O), 155.0 (C═O), 135.8 (CH), 135.3 (C), 133.4 (CH), 132 (CH), 127.9 (CH), 83.7 (C), 79.8 (C), 54.5 (CH), 52.1 (CH₃), 38.2 (CH₂), 28.2 (3 CH₃ of ^{t}Bu), 24.8 (4 CH₃ of BPin), (minor/para isomer) 172.2 (C═O), 155.0 (C═O), 139.2 (C), 135.0 (CH), 128.6 (CH), 83.7 (C), 79.9 (C), 54.3 (CH), 52.1 (CH₃), 38.4 (CH₂), 28.2 (3 CH₃ of ^{t}Bu), 24.9 (4 CH₃ of BPin); ¹¹B NMR (CDCl₃, 96 MHz): δ 31.2; FT-IR (neat) vₘₐₓ: 3447, 3366, 2979, 2934, 1748, 1717, 1503, 1435, 1362, 1167, 1146, 1080, 857, 712 cm⁻¹.

Table 2, Entry 2: Diborylation of Boc-L-phenylalanine methyl ester.

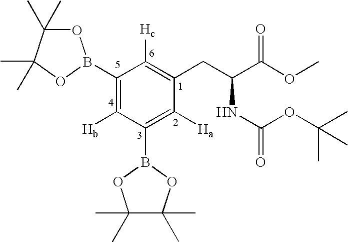

The general procedure was applied to Boc-L-phenylalanine methyl ester (140 mg, 0.50 mmol, 1 equiv) and B₂Pin₂ (254 mg, 1.00 mmol, 2.00 equiv) at 120° C. in a microwave for 1.0 h. There was 88.5% conversion by GC-FID and the ratio of S.M. to meta isomer to para isomer to diborylated product was 11.5:29.9:19.1:39.5 by GC-FID of the crude reaction mixture. Column chromatography (hexanes/diethyl ether 75:25) furnished the desired diborylated product as a white solid (48 mg, 18% yield, mp 69-79° C.). ¹H NMR (CDCl₃, 500 MHz): δ 8.13 (s, 1H, H_{b}), 7.63 (s, 2H, Hₐ, H_{c}), 4.94-4.92 (d, J=7.7 Hz, 1H, NH), 4.53-4.50 (q, J=6.5 Hz, 1H, CH), 3.69 (s, 3H, CH₃ of Me), 3.14-2.97 (m, 2H, CH₂), 1.40 (br s, 9H, CH₃ of ^{t}Bu), 1.31 (br s, 24H, CH₃ of BPin); ¹³C NMR {¹H} (CDCl₃, 125 MHz): δ 172.4 (C═O), 155.0 (C═O), 139.9 (CH), 138.5 (CH), 134.6 (C), 83.7 (C), 79.8 (C), 54.7 (CH), 52.1 (CH₃), 38.1 (CH₂), 28.3 (3 CH₃ of ^{t}Bu), 24.9 (8 CH₃ of BPin); ¹¹B NMR (CDCl₃, 96 MHz): δ 31.4; FT-IR (neat) vₘₐₓ: 3447, 3366, 2979, 2934, 1746, 1719, 1599, 1503, 1453, 1393, 1327, 1167, 1144, 968, 847, 720 cm⁻¹; [α]²⁰_{D} +34.5(c 0.4, CH₂Cl₂); Anal. Calcd for C₂₇H₄₃B₂NO₈: C, 61.04; H, 8.16; N, 2.64. Found: C, 60.99; H, 8.22; N, 2.50.

Table 2, Entry 3: Borylation of Boc-3-chloro-L-phenylalanine methyl ester.

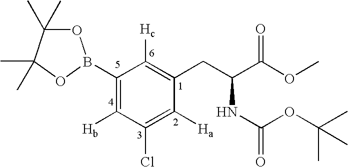

The general procedure was applied to Boc-3-chloro-L-phenylalanine methyl ester (314 mg, 1.00 mmol, 1 equiv) and B₂Pin₂ (305 mg, 1.20 mmol, 1.20 equiv) at 120° C. for 20 mins. Passing the crude material through a silica plug (methylenechloride/diethyl ether 95:5) furnished the product as a pale yellow solid (376 mg, 85% yield, mp 86-89° C.). ¹H NMR (CDCl₃, 500 MHz): δ 7.63 (s, 1H, H_{b}), 7.41 (s, 1H, Hₐ), 7.17 (s, 1H, H_{c}), 4.98-4.96 (d, J=7.6 Hz, 1H, NH), 4.54-4.50 (ddd, J=5.8, 6.2, 8.2 Hz, 1H, CH), 3.70 (s, 3H, CH₃ of Me), 3.12-2.95 (m, 2H, CH₂), 1.41 (br s, 9H, CH₃ of ^{t}Bu), 1.31 (br s, 12H, CH₃ of BPin); ¹³C NMR {¹H} (CDCl₃, 125 MHz) δ 172.0 (C═O), 154.9 (C═O), 137.5 (C), 133.9 (CH), 133.7 (CH), 133.1 (CH), 131.9 (CH), 84.1 (C), 79.9 (C), 54.3 (CH), 52.2 (CH₃), 37.7 (CH₂), 28.2 (3 CH₃ of ^{t}Bu), 24.8 (4 CH₃ of BPin); ¹¹B NMR (CDCl₃, 96 MHz): δ 30.5; FT-IR (neat) vₘₐₓ: 3366, 2980, 1748, 1719, 1503, 1358, 1167, 1146, 860, 708 cm⁻¹; [α]²⁰_{D} +47.0(c 0.3, CH₂Cl₂); Anal. Calcd for C₂₁H₃₁BClNO₆: C, 57.36; H, 7.11; N, 3.19. Found: C, 57.20; H, 7.50; N, 3.58.

Table 2, Entry 5: Monoborylation of Protected Tryptophan:

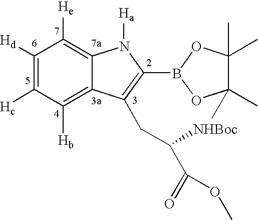

In glove box, the starting indole substrate (159 mg, 0.5 mmol, 1 equiv) was weighed in a 20 mL vial and dissolved in 10 mL of methyl tert-butyl ether. Two separate test tubes were charged with [Ir(OMe)(COD)]₂ (10 mg, 0.015 mmol, 6 mol % Ir) and dtbpy (8 mg, 0.03 mmol, 6 mol %). HBPin (15 μL, 0.2 equiv) was added to the [Ir(OMe)(COD)]₂ test tube. Methyl tert-butyl ether (1 mL) was added to the dtbpy containing test tube in order to dissolve the dtbpy. The dtbpy solution was then mixed with the [Ir(OMe)(COD)]₂ and HBPin mixture. After mixing for one minute, the resulting solution was transferred to the 20 mL reaction vial containing the indole substrate. Additional methyl tert-butyl ether (2×1 mL) was used to wash the test tubes and the washings were transferred to the reaction vial. B₂Pin₂ (127 mg, 0.5 mmol, 1 equiv) was weighed in a test tube and was transferred to the reaction vial by dissolving in methyl tert-butyl ether (5 mL). The reaction vial was stirred at room temperature inside the glove box. The reaction was monitored by TLC. The reaction was stopped after 45 minutes. Volatile materials were removed on a rotary evaporator. The ratio of starting indole substrate to monoborylated product to diborylated product was 0.42:1.0:0.05 by ¹H NMR of the crude reaction mixture. The crude material was dissolved in CH₂Cl₂ (2 mL) and placed on a silica column. Column chromatography (silica gel, hexanes/ethyl acetate 3:1, R_{f} 0.3) gave three fractions. The first fraction (13 mg) was 1:1 mixture of mono and diborylated products. The second fraction (95 mg, 43% yield based on starting indole used) was pure monoborylated product. The third fraction was recovered unreacted starting indole substrate (50 mg). The monoborylated product in the second fraction was obtained as a white solid (95 mg, 63% yield based on recovered starting indole, mp 183-185° C.). The monoborylated product exists as 80:20 mixture of two amide rotamers at room temperature by ¹H NMR. Different ¹H NMR peaks for the two amide rotamers coalesce together at 70° C. in C₆D₆. Regiochemistry of the monoborylated product was assigned by NMR spectroscopy. ¹H NMR (CDCl₃, 300 MHz): δ 8.48 (br s, 1H, N—H), 7.66 (d, J=8.1 Hz, 1H), 7.32 (d, J=8.1 Hz, 1H), 7.19-7.24 (dt, J=7.5, 1.0 Hz, 1H), 7.07-7.12 (dt, J=7.5, 1.0 Hz, 1H), 5.94 (d, J=7.1 Hz, 1H, N—H), 4.32-4.38 (m, 1H), 3.71 (s, 3H), 3.27-3.45 (m, 2H), 1.39 (br s, 6H, 2 CH₃ of BPin), 1.37 (br s, 6H, 2 CH₃ of BPin), 1.18-1.34 (br, 9H, CH₃ of Boc); ¹³C NMR {¹H} (CDCl₃, 75 MHz): δ 173.4 (C═O), 155.6 (C═O), 138.3 (CH), 128.0 (C), 124.0 (CH), 123.3 (C), 119.7 (CH), 119.5 (C), 111.4 (CH), 84.5 (2 C), 79.2 (C), 55.2 (CH), 51.9 (OCH₃), 28.3 (CH₃ of Boc), 27.6 (CH₂), 25.0 (2 CH₃ of BPin), 24.7 (2 CH₃ of BPin); ¹¹B NMR (CDCl₃, 96 MHz): δ 29.4; FT-IR (neat) vₘₐₓ: 3379, 2978, 1718, 1550, 1516, 1390, 1325, 1267, 1169, 1112, 856, 744 cm⁻¹; GC-MS (EI) m/z (% relative intensity): M⁺444 (0.97), 370 (0.52), 344 (0.40), 327 (0.73), 285 (1.3), 256 (100), 155 (35.2); Anal. Calcd for C₂₃H₃₃BN₂O₆: C, 62.17; H, 7.49; N, 6.30. Found: C, 62.84; H, 7.88; N, 6.11; HRMS (EI): m/z 444.2433 [(M⁺; Calcd for C₂₃H₃₃BN₂O₆: 444.2432].

Table 2, Entry 6: Diborylation of Protected Tryptophan:

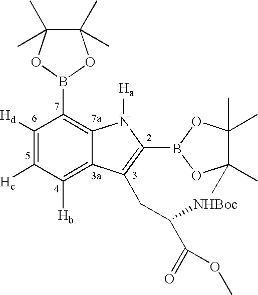

In a glove box, the starting indole substrate (159 mg, 0.5 mmol, 1 equiv) and B₂Pin₂ (254 mg, 1.0 mmol, 2 equiv) was weighed in a 20 mL vial. Two separate test tubes were charged with [Ir(OMe)(COD)]₂ (10 mg, 0.015 mmol, 6 mol % Ir) and dtbpy (8 mg, 0.03 mmol, 6 mol %). HBPin (20 □L, 18 mg, 0.14 mmol, 0.28 equiv) along with 1 mL of methyl tert-butyl ether was added to the [Ir(OMe)(COD)]₂ test tube. Methyl tert-butyl ether (1 mL) was added to the dtbpy test tube in order to dissolve the dtbpy. The dtbpy solution was then mixed with the [Ir(OMe)(COD)]₂ and HBPin mixture. After mixing for one minute, the resulting solution was transferred to the 20 mL reaction vial containing indole substrate and B₂Pin₂. Additional methyl tert-butyl ether (1 mL) was used to wash the test tubes and the washings were transferred to the reaction vial. The reaction vial was stirred at room temperature inside the glove box for 19 hrs. At this point the volatile materials were removed and the crude material was purified via a gradient column (10% ethyl acetate/hexanes to 30% ethyl acetate/hexanes) on silica gel. The product was isolated as a white solid (153 mg, 54% yield, mp 88-94° C.). The diborylated product exists as 80:20 mixture of two amide rotamers at room temperature by ¹H NMR. Different ¹H NMR peaks for the two amide rotamers coalesce at 70° C. in C₆D₆. Regiochemistry of the diborylated product was assigned by NMR spectroscopy. ¹H NMR (CDCl₃, 500 MHz): δ 9.21 (br s, 1H, Hₐ), 7.78-7.76 (d, J=7.9 Hz, 1H, H_{b}/H_{d}), 7.70-7.69 (d, J=6.8 Hz, 1H, H_{b}/H_{d}), 7.13-7.10 (t, J=7.8 Hz, 1H, H_{c}), 5.99-5.97 (d, J=6.7 Hz, 1H, NH), 4.34-4.30 (m, 1H, CH), 3.70 (s, 3H, CH₃ of Me), 3.43-3.30 (m, 2H, CH₂), 1.41 (br s, 6H, 2 CH₃ of BPin), 1.39 (br s, 18H, 6 CH₃ of BPin), 1.34 (br s, 9H, CH₃ of ^{t}Bu); ¹³C NMR {¹H} (CDCl₃, 125 MHz): δ 173.5 (C═O), 155.6 (C═O), 142.9 (C), 131.7 (CH), 126.8 (C), 123.0 (CH), 122.9 (C), 119.2 (CH), 84.3 (C), 83.8 (C), 79.2 (C), 55.3 (CH), 52.1 (CH₃), 28.3 (3 CH₃ of ^{t}Bu), 27.2 (CH₂), 25.0 (4 CH₃ of BPin), 24.9 (2 CH₃ of BPin), 24.6 (2 CH₃ of BPin); ¹¹B NMR (CDCl₃, 96 MHz): δ 30.2; FT-IR (neat) vₘₐₓ: 3453, 3391, 3056, 2980, 2934, 1754, 1719, 1551, 1514, 1497, 1441, 1416, 1391, 1368, 1337, 1294, 1207, 1167, 1136, 1101, 853, 683 cm⁻¹; [α]²⁰D+15.2(c 0.4, CH₂Cl₂); Anal. Calcd for C₂₉H₄₄B₂N₂O₈: C, 61.08; H, 7.78; N, 4.91. Found: C, 61.02; H, 8.15; N, 4.98.

Table 3, Entry 2: Pd-catalyzed Suzuki-Miyaura Coupling of N-Boc-3-(4,4,5,5-tetramethyl-1,3,2-dioxaboryl)pyrrole.

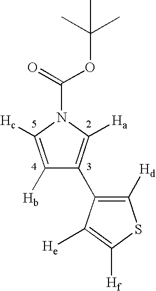

In a glove box, a Schlenk flask, equipped with a magnetic stirring bar, was charged with N-Boc-3-(4,4,5,5-tetramethyl-1,3,2-dioxaboryl)pyrrole (293 mg, 1.00 mmol, 1.0 equiv), Pd₂ dba₃ (9.2 mg, 0.01 mmol), XPhos (19.1 mg, 0.04 mmol) and powdered, anhydrous K₃PO₄ (425 mg, 2.00 mmol, 2.0 equiv). The Schlenk tube was sealed and brought out of the glove box. The Schlenk tube was opened under argon and was capped with a rubber septum. The Schlenk tube was then evacuated and backfilled with argon (this sequence was carried out two times). t-Amyl alcohol (2.00 mL) and 3-chlorothiophene (93 □L, 119 mg, 1.00 mmol, 1.0 equiv) were added via syringe through the septum. The septum was then replaced with a Teflon screwcap and flushed with argon twice as mentioned previously. The Schlenk tube was then sealed and heated at 80° C. for 12 hrs. At this point the reaction mixture was allowed to cool to room temperature. The reaction solution was then filtered through a thin pad of silica gel (eluting with ethyl acetate) and the eluent was concentrated under reduced pressure. The crude material so obtained was purified via flash chromatography on silica gel (5% EtOAc/hexanes) to provide the Suzuki product as a pale yellow solid (212 mg, 85% yield, mp 49-51° C.). ¹H NMR (CDCl₃, 300 MHz): δ 7.40-7.39 (t, J=1.7 Hz, 1H, Hₐ), 7.32-7.30 (dd, J=4.9, 2.9 Hz, 1H, H_{f}), 7.27-7.23 (m, 3H, H_{c}, H_{d}, Hₑ), 6.45-6.43 (dd, J=3.2, 1.7 Hz, 1H, H_{b}), 1.60 (br s, 9H, CH₃ of ^{t}Bu); ¹³C NMR {¹H} (CDCl₃, 125 MHz): δ 148.8 (C═O), 135.6 (C), 125.9 (2×CH), 123.2 (C), 120.8 (CH), 118.6 (CH), 115.6 (CH), 110.8 (CH), 83.8 (C), 28.0 (3 CH₃ of ^{t}Bu); FT-IR (neat) vₘₐₓ: 3144, 3108, 2980, 2934, 1742, 1489, 1412, 1372, 1345, 1327, 1314, 1271, 1258, 1227, 1161, 1146, 1078, 974, 851, 770 cm⁻¹; GC-MS (EI) m/z (% relative intensity): M⁺249 (3), 193 (100), 149 (68), 148 (26), 121 (20), 57 (33); Anal. Calcd for C₁₃H₁₅NO₂S: C, 62.62; H, 6.06; N, 5.62. Found: C, 62.53; H, 5.99; N, 5.52.

Table 3, Entry 3: One-pot borylation/Suzuki coupling of N-Boc pyrrole.

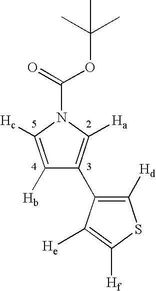

The general borylation procedure was applied to N-Boc pyrrole (167 μL, 167 mg, 1.00 mmol, 1 equiv) and HBPin (217 μL, 192 mg, 1.50 mmol, 1.50 equiv) at 60° C. for 30 h. The GC-FID showed 100% consumption of the starting indole. The reaction mixture was pumped down under high vacuum for 2 h to remove the volatile materials. The Schlenk flask was brought into the glove box, where Pd₂ dba₃ (9.2 mg, 0.01 mmol), XPhos (19.1 mg, 0.04 mmol) and powdered, anhydrous K₃PO₄ (425 mg, 2.00 mmol, 2.0 equiv) were added. The Schlenk tube was sealed and brought out of the glove box. The Schlenk tube was opened under argon and was capped with a rubber septum. The Schlenk tube was then evacuated and backfilled with argon (this sequence was carried out two times). t-Amyl alcohol (2.00 mL) and 3-chlorothiophene (93 μL, 119 mg, 1.00 mmol, 1.0 equiv) were added via syringe through the septum. The septum was then replaced with a Teflon screwcap and flushed with argon twice as mentioned previously. The Schlenk tube was then sealed and heated at 80° C. for 48 hrs. At this point the reaction mixture was allowed to cool to room temperature. The reaction solution was then filtered through a thin pad of silica gel (eluting with ethyl acetate) and the eluent was concentrated under reduced pressure. The crude material so obtained was purified via flash chromatography on silica gel (5% EtOAc/Hexanes) to provide the Suzuki product as a pale yellow solid (189 mg, 76% yield, mp 49-51° C.).

### General Procedure for Deprotection

Unless otherwise specified, all reactions followed this general procedure. A Schlenk flask, equipped with a magnetic stirring bar, was charged with the corresponding substrate and heated in air at 180° C. until bubbling ceases. (Note: The substrate decomposed when heated under nitrogen) The crude material was dissolved in CH₂Cl₂ and passed through a plug of silica. Regiochemistry of the borylated products was assigned by NMR spectroscopy (1H, ¹³C, gCOSY).

Table 4, Entry 1: Deprotection of N-Boc-3-(4,4,5,5-tetramethyl-1,3,2-dioxaboryl)pyrrole.

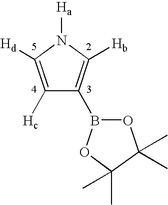

The general procedure for deprotection was applied to N-Boc-3-(4,4,5,5-tetramethyl-1,3,2-dioxaboryl)pyrrole at 180° C. for 35 mins. The product was isolated as a white solid (1548 mg, 80% yield, mp 102-104° C.). ¹H NMR (CDCl₃, 500 MHz): δ 8.61 (br s, 1H, Hₐ), 7.24-7.22 (ddd, J=1.5, 1.7, 2.7 Hz, 1H, H_{b}), 6.83-6.81 (ddd, J=1.7, 2.5, 2.5 Hz, 1H, H_{d}), 6.55-6.54 (ddd, 1.5, 2.5, 2.6 Hz, 1H, Hₑ), 1.31 (br s, 12H, CH₃ of BPin); ¹³C NMR {¹H} (CDCl₃, 125 MHz): δ 127.0 (CH), 118.6 (CH), 113.8 (CH), 82.9 (C), 24.8 (4 CH₃ of BPin); ¹¹B NMR (CDCl₃, 96 MHz): δ 30.6; FT-IR (neat) vₘₐₓ: 3372, 3121, 2980, 2930, 1549, 1495, 1429, 1418, 1383, 1371, 1318, 1291, 1165, 1140, 1107, 966, 930, 860, 737, 691, 592 cm⁻¹; GC-MS (EI) m/z (% relative intensity): M⁺193 (100), 178 (20), 150 (9), 107 (21); Anal. Calcd for C₁₀H₁₆BNO₂: C, 62.22; H, 8.35; N, 7.26. Found: C, 62.46; H, 8.35; N, 7.35.

Table 4, Entry 2: Deprotection of N-Boc-2-methyl-4-(4,4,5,5-tetramethyl-1,3,2-dioxaboryl)pyrrole carboxylate.

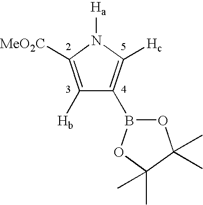

The general procedure for deprotection was applied to N-Boc-2-methyl-4-(4,4,5,5-tetramethyl-1,3,2-dioxaboryl)pyrrolecarboxylate (150 mg, 0.43 mmol) at 180° C. for 18 mins. The product was isolated as a white solid (82 mg, 76% yield, mp 133-135° C.). ¹H NMR (CDCl₃, 500 MHz): δ 9.42 (br s, 1H, Hₐ), 7.32-7.31 (dd, J=2.9, 1.5 Hz, 1H, H_{c}), 7.22-7.21 (dd, J=2.4, 1.5 Hz, 1H, H_{b}), 3.82 (s, 3H, CH₃), 1.29 (br s, 12H, CH₃ of BPin); ¹³C NMR {¹H} (CDCl₃, 125 MHz): δ 161.8 (C═O), 131.2 (CH), 124.2 (C), 121.5 (CH), 83.5 (C), 51.8 (CH₃), 25.1 (4 CH₃ of BPin); ¹¹B NMR (CDCl₃, 96 MHz): δ 30.2; FT-IR (neat) vₘₐₓ: 3308, 2978, 1707, 1564, 1499, 1443, 1363, 1284, 1271, 1211, 1144, 1078, 968, 857, 772, 743, 691 cm⁻¹; GC-MS (EI) m/z (% relative intensity): M⁺251 (100), 236 (25), 208 (29), 176 (18), 165 (27), 152 (7), 150 (8), 120 (9); Anal. Calcd for C₁₂H₁₈BNO₄: C, 57.40; H, 7.23; N, 5.58. Found: C, 57.19; H, 7.37; N, 5.51.

Table 4, Entry 3: Deprotection of N-Boc-2-methyl-4-(4,4,5,5-tetramethyl-1,3,2-dioxaboryl)pyrrole.

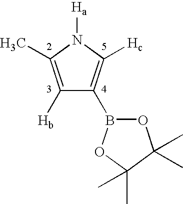

The general procedure for deprotection was applied to N-Boc-2-methyl-4-(4,4,5,5-tetramethyl-1,3,2-dioxaboryl)pyrrole (100 mg, 0.33 mmol) at 140° C. for 16 hrs. The product was isolated as a white solid (49 mg, 72% yield, mp 102-108° C.). ¹H NMR (CDCl₃, 500 MHz): δ 8.11 (br s, 1H, Hₐ), 7.10-7.08 (dd, J=2.4, 1.7 Hz, 1H, H_{c}), 6.18-6.17 (m, 1H, H_{b}), 2.25 (d, J=0.7 Hz, 3H, CH₃), 1.29 (br s, 12H, CH₃ of BPin); ¹³C NMR {¹H} (CDCl₃, 125 MHz): δ 128.6 (C), 125.9 (CH), 111.2 (CH), 82.7 (C), 24.8 (4 CH₃ of BPin), 12.6 (CH₃); ¹¹B NMR (CDCl₃, 96 MHz): δ 30.6; FT-IR (neat) vₘₐₓ 3362, 2977, 2926, 1582, 1522, 1458, 1391, 1374, 1291, 1212, 1148, 1130, 970, 943, 858, 816, 708, 691 cm⁻¹; GC-MS (EI) m/z (% relative intensity): M⁺207 (100), 192 (16), 121 (19), 106(13); Anal. Calcd for C₁₁H₁₈BNO₂: C, 63.80; H, 8.76; N, 6.76. Found: C, 63.80; H, 9.03; N, 6.59.

Table 4, Entry 4: Deprotection of N-Boc-3-(4,4,5,5-tetramethyl-1,3,2-dioxaboryl)indole.

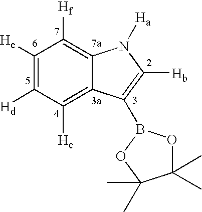

The general procedure for deprotection was applied to N-Boc-3-(4,4,5,5-tetramethyl-1,3,2-dioxaboryl)indole at 180° C. for 45 mins. The product was isolated as a white solid (453 mg, 64% yield, mp 163-165° C.). ¹H NMR (CDCl₃, 500 MHz): δ 8.49 (br s, 1H, Hₐ), 8.08-8.06 (m, 1H, H_{c}/H_{f}) 7.61-7.60 (d, J=2.5 Hz, 1H, H_{b}), 7.36-7.34 (m, 1H, H_{c}/H_{f}), 7.21-7.16 (m, 2H, H_{d}, Hₑ), 1.37 (br s, 12H, CH₃ of BPin); ¹³C NMR {¹H} (CDCl₃, 125 MHz): δ 136.7 (C), 133.9 (CH), 131.6 (C), 122.5 (CH), 122.2 (CH), 120.5 (CH), 110.9 (CH), 82.9 (C), 24.9 (4 CH₃ of BPin); ¹¹B NMR (CDCl₃, 96 MHz): δ 30.5; FT-IR (neat) vₘₐₓ: 3413, 2980, 2932, 1484, 1458, 1439, 1335, 1138, 1032, 851, 768, 743, 671 cm⁻¹; GC-MS (EI) m/z (% relative intensity): M⁺243 (100), 228 (49), 157 (24), 143 (48), 117 (16); Anal. Calcd for C₁₄H₁₈BNO₂: C, 69.17; H, 7.46; N, 5.76. Found: C, 69.4; H, 7.51; N, 5.73.

### REFERENCES CITED

^{b} (a) Iverson, C. N.; Smith, M. R., III, J. Am. Chem. Soc. 1999, 121, 7696-7697; (b) Cho, J.-Y.; Iverson, C. N.; Smith, M. R. III, J. Am. Chem. Soc. 2000, 122, 12868-12869; (c) Cho, J. Y.; Tse, M. K.; Holmes, D.; Maleczka, R. E., Jr.; Smith, M. R., III, Science 2002, 295, 305-308; (d) Ishiyama, T.; Takagi, J.; Ishida, K.; Miyaura, N.;. Anastasi, N. R.; Hartwig, J. F., J. Am. Chem. Soc. 2002, 124, 390-391. (e) Ishiyama, T.; Takagi, J.; Hartwig, J. F.; Miyaura, N., Angew. Chem.-Int. Edit. 2002, 41, 3056-3058; (f) Takagi, J.; Sato, K.; Hartwig, J. F.; Ishiyama, T.; Miyaura, N., Tetrahedron Lett. 2002, 43, 5649-5651; (g) Ishiyama, T.; Nobuta, Y.; Hartwig, J. F.; Miyaura, N., Chem. Commun. 2003, 2924-2925 (h) Ishiyama, T.; Takagi, J.; Yonekawa, Y.; Hartwig, J. F.; Miyaura, N., Adv. Synth. Catal. 2003, 345, 1103-1106; (i) Maleczka, R. E., Jr.; Shi, F.; Holmes, D.; Smith, M. R., III J. Am. Chem. Soc. 2003, 125, 7792-7793; (j) Boller, T. M.; Murphy, J. M.; Hapke, M.; Ishiyama, T.; Miyaura, N.; Hartwig, J. F., J. Am. Chem. Soc. 2005, 127, 14263-14278; (1) Chotana, G. A.; Rak, M. A.; Smith, M. R., III, J. Am. Chem. Soc. 2005, 127, 10539-10544; (m) Coventry, D. N.; Batsanov, A. S.; Goeta, A. E.; Howard, J. A. K.; Marder, T. B.; Perutz, R. N., Chem. Commun. 2005, 2172-2174; (n) Holmes, D.; Chotana, G. A.; Maleczka, R. E.; Smith, M. R., Org. Lett. 2006, 8, 1407-1410; (O) Mkhalid, I. A. I.; Coventry, D. N.; Albesa-Jove, D.; Batsanov, A. S.; Howard, J. A. K.; Perutz, R. N.; Marder, T. B., Angew. Chem.-Int. Edit. 2006, 45, 489-491; (p) Paul, S.; Chotana, G. A.; Holmes, D.; Reichle, R. C.; Maleczka, R. E., Jr.; Smith, M. R., III, J. Am. Chem. Soc. 2006, 128, 15552-15553; (q) Shi, F.; Smith, M. R., III; Maleczka, R. E., Jr., Org. Lett. 2006, 8, 1411-1414; (r) Ishiyama, T.; Miyaura, N., Pure Appl. Chem. 2006, 78, 1369-1375; (s) Murphy, J. M.; Tzschucke, C. C.; Hartwig, J. F., Org. Lett. 2007, 9, 757-760; (t) Tzschucke, C. C.; Murphy, J. M.; Hartwig, J. F., Org. Lett. 2007, 9, 761-764.
^{c} Tse, M. K.; Cho, J. Y.; Smith, M. R., III Org. Lett. 2001, 3, 2831-2833.
^{d} Greene, T. W.; Wuts, P. G. M. In Protective Groups in Organic Synthesis; 3rd ed.; John Wiley & Sons, Inc.: New York, 1999, pp 518-520, 617.
^{e} For N-Boc protected pyrroles and indoles, only a handful of selective halogenations^{5a,b} and C—C bond forming reactions^{5c,d} at the 3-position have been reported: (a) Curtin, M. L.; Davidsen, S. K.; Heyman, H. R.; Garland, R. B.; Sheppard, G. S.; Florjancic, A. S.; Xu, L. H.; Carrera, G. M.; Steinman, D. H.; Trautmann, J. A.; Albert, D. H.; Magoc, T. J.; Tapang, P.; Rhein, D. A.; Conway, R. G.; Luo, G. J.; Denissen, J. F.; Marsh, K. C.; Morgan, D. W.; Summers, J. B. J. Med. Chem. 1998, 41, 74-95; (b) Benhida, R.; Blanchard, P.; Fourrey, J. L. Tetrahedron Lett. 1998, 39, 6849-6852; (c) Tsukada, N.; Murata, K.; Inoue, Y. Tetrahedron Lett. 2005, 46, 7515-7517; (d) Ishikura, M.; Uemura, R.; Yamada, K.; Yanada, R. Heterocycles 2006, 68, 2349-2356.
^{f} We have carried out several “one-pot” borylation/oxidations of Boc-protected aryl and heteroaryl amino acids. These will be reported separately.
^{g} Billingsley, K.; Buchwald, S. L. J. Am. Chem. Soc. 2007, 129, 3358-3366.
^{h} Greene, T. W.; Wuts, P. G. M. In Protective Groups in Organic Synthesis; 3rd ed.; John Wiley & Sons, Inc.: New York, 1999, pp 520-522, 618.
ⁱ While the Boc group from protected amino acids, such as the product in Table 2, entry 3, could be removed with TFA, we could not achieve analogous deprotections for the substrates in Table 4.
^{j} Uson, R.; Oro, L. A.; Cabeza, J. A. Inorg. Synth. 1985, 23, 126-130.
^{k} Routier, S.; Coudert, G.; Merour, J. Y.; Caignard, D. H. Tetrahedron Lett. 2002, 43, 2561-2564.
^{l} Zhang, Z.; Yang, Z.; Meanwell, N. A.; Kadow, J. F.; Wang, T. J. Org. Chem. 2002, 67, 2345-2347.
^{m} Kuhakarn, C.; Kittigowittana, K.; Pohmakotr, M.; Reutrakul, V. Arkinov. 2005, part 1, 143-153.
ⁿ Boller, T. M.; Murphy, J. M.; Hapke, M.; Ishiyama, T.; Miyaura, N.; Hartwig, J. F. J. Am. Chem. Soc. 2005, 127, 14263-14278.

The compounds of the present invention are intermediates to natural cytotoxic compounds which have cytotoxic, anticancer and antiviral activity. The compounds are also intermediates to synthetic anticancer and antiviral agents based upon the N-protected compounds as intermediates.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

We claim:

1. A process for producing N-substituted boryl compounds (I-III) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C— cyano, N—, O—, and S-containing groups, and C-boryl and the boryl group is derived from HBPin or B₂Pin, wherein Ar is selected from the group consisting of aryl or heteroaryl, wherein n is equal to zero to two, 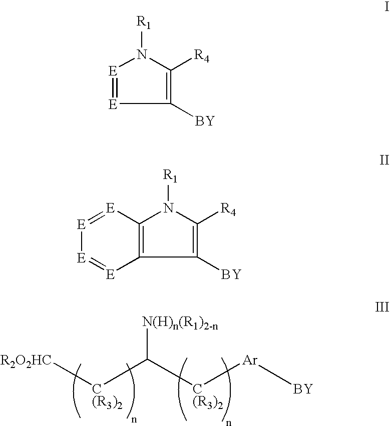
which comprises:
(a) reacting N-protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group and the boryl group is derived from HBPin or B₂Pin, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two, 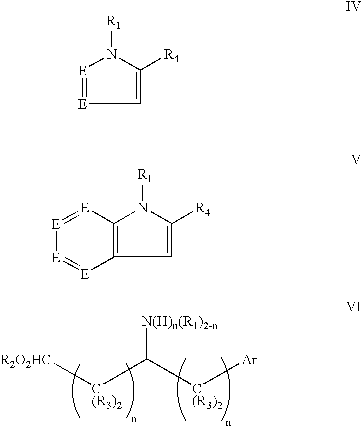
in a reaction mixture with a non-reactive solvent selected from, but not limited to, aliphatic hydrocarbons and ethers at temperatures between about 0 and 150° C. with an HB or B—B organic compound, in the presence of a catalytically effective amount of an iridium complex catalytic composition comprising an iridium complex of the formula: (BY)ₙ—Ir-(ligand)ₘ where n is equal to one to five and m is equal to one to three, excluding hydrogen, bonded to the iridium BY is a boron moiety and the ligand is selected from the group consisting of a phosphorus organic ligand, an organic amine, an imine, a nitrogen heterocycle, and an ether wherein the ligand is at least in part bonded to the iridium, to form the compounds (I-III) in the reaction mixture; and
(b) evaporating the solvent and portions of the reaction mixture which are volatile from the reaction mixture to produce the compound (I-III).

2. An N-substituted boryl compound (I-III) selected from the group consisting of indole, azaindole, phenyl alanine, aryl amino acids, tryptophan, thiophene amino acids, heteroatom aromatic amino acids, pyrrole, and azole wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two.

3. A process for producing a N-tert-butoxycarbonyl substituted protected boryl compound (I-III), wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two, which comprises:
(a) reacting an N-tert-butoxycarbonyl protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two, with an HB or B—B organic compound in a reaction mixture with a non-reactive first solvent selected from, but not limited to, aliphatic hydrocarbons and ethers at elevated temperatures between about 0 and 150° C. in the presence of a catalytically effective amount of an iridium complex catalytic composition comprising an iridium complex of the formula: (BY)ₙ—Ir-(ligand) m where n is equal to one to five and m is equal to one to three, excluding hydrogen, bonded to the iridium, wherein BY is a boron moiety and the ligand is selected from the group consisting of a phosphorus organic ligand, an organic amine, an imine, a nitrogen heterocycle, and an ether wherein the ligand is at least in part bonded to the iridium, in a molar ratio of complex to ligand between 1 to 3 and 1 to 1, wherein the ligand is at least in part bonded to the iridium, to form compounds (I-III);
(b) evaporating the first solvent and portions of the reaction mixture which are volatile from the reaction mixture;
(c) dissolving the compound (I-III) in a second solvent; and
(d) isolating the compound (I-III) from the second solvent.

4. An N-tert-butoxycarbonyl substituted boryl compound (I-III) selected from the group consisting of indole, azaindole, phenyl alanine, aryl amino acids, tryptophan, thiophene amino acids, heteroatom aromatic amino acids, pyrrole, and azole wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two.

5. A process for producing a N-tert-butoxycarbonyl substituted protected boryl compound (I-III), wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two, which comprises:
(a) reacting an N-tert-butoxycarbonyl protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two, with an HB or B—B organic compound in a reaction mixture with a non-reactive first solvent selected from, but not limited to, aliphatic hydrocarbons and ethers at elevated temperatures between about 0 and 150° C. in the presence of a catalytically effective amount of an iridium complex catalytic composition comprising an iridium complex of the formula: (BY)ₙ—Ir-(ligand)ₘ where n is equal to one to five and m is equal to one to three, excluding hydrogen, bonded to the iridium, wherein BY is a boron moiety and the ligand is selected from the group consisting of a phosphorus organic ligand, an organic amine, an imine, a nitrogen heterocycle, and an ether wherein the ligand is at least in part bonded to the iridium, in a molar ratio of complex to ligand between 1 to 3 and 1 to 1, wherein the ligand is at least in part bonded to the iridium, to form compounds (I-III); and
(b) evaporating the solvent and portions of the reaction mixture which are volatile from the reaction mixture to produce the compound (I-III).

6. A process for producing boryl compounds (VII-IX) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two, 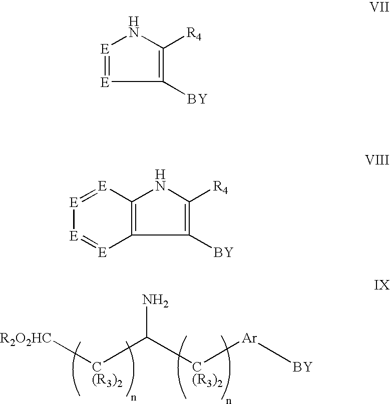
which comprises heating at temperatures between 180 and 200° C. in air an N-tert-butoxycarbonyl substituted compound (I-III) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N—, O—, and S-containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two.

7. A process for producing N-substituted compounds (X-XII) where the nitrogen containing species is selected from the group consisting of an indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N—, O—, and S-containing groups, wherein E is selected from the group consisting of CH, N, C-alkyl, C-aryl, C-heteroaryl, C-ester, C-halide, C-cyano, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl, wherein n is equal to zero to two, wherein R₅ is each selected from the group consisting of alkyl, aryl, heteroaryl, cycloalkyl, and N—, S—, and O-containing groups, 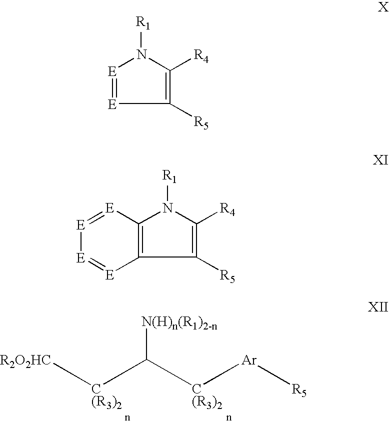
which comprises
(a) reacting N-protected compounds (IV-VI) where the nitrogen containing species is selected from the group consisting of indole, azaindole, phenyl alanine, aryl amino acids, tryptophan, thiophene amino acids, heteroatom aromatic amino acids, pyrrole, and azole, wherein R₁ is selected from the group consisting of tert-butoxycarbonyl, (benzyloxy)carbonyl, N,N-dimethylaminosulfonyl, N,N-dimethylcarboxamide, para-toluenesulfonyl, 9H-Fluoren-9-ylmethyloxycarbonyl, and other common nitrogen protecting groups, wherein R₂ is selected from the group consisting of H, alkyl, aryl, carbonyl, and other carboxylic acid protecting groups, wherein R₃ is selected from the group consisting of H, alkyl, aryl, carbonyl, and N, O, and S containing groups, wherein R₄ is selected from the group containing hydrogen, boryl, halo, cyano, alkyl, alkoxy, thioalkyl, amino alkyl, acyl, alkyl aminoacyl, trifluoro alkyl, aryl, alkyl silyl, and containing 1 to 8 carbon atoms except for the halo group and boryl group and the boryl group is derived from HBPin or B₂Pin, wherein E is selected from the group consisting of CH, N, C-alkyl, C-aryl, C-heteroaryl, C-ester, C-halide, C-cyano, N—, O—, and S-containing groups, and C-boryl and the boryl group is derived from HBPin or B₂Pin, wherein Ar is selected from the group consisting of aryl or heteroaryl with at least one C—H bond, wherein n is equal to zero to two, 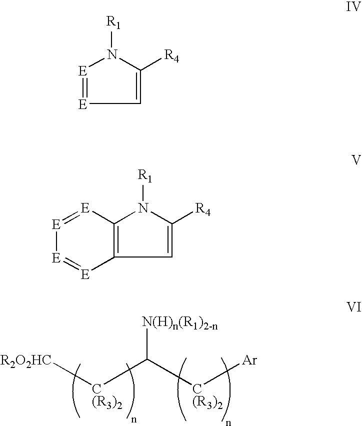
in a reaction mixture with a non-reactive solvent selected from, but not limited to, aliphatic hydrocarbons and ethers at temperatures between about 0 and 150° C. with an HB or B—B organic compound, in the presence of a catalytically effective amount of an iridium complex catalytic composition comprising an iridium complex of the formula: (BY)ₙ—Ir-(ligand)ₘ where n is equal to one to five and m is equal to one to three, excluding hydrogen, bonded to the iridium BY is a boron moiety and the ligand is selected from the group consisting of a phosphorus organic ligand, an organic amine, an imine, a nitrogen heterocycle, and an ether wherein the ligand is at least in part bonded to the iridium, to form the compounds (I-III) in the reaction mixture;
(b) evaporating the solvent and portions of the reaction mixture which are volatile from the reaction mixture to produce the compound (I-III);
(c) reacting in the same reaction vessel without purification the N-substituted boryl compound (I-III) with an alkyl, aryl, heteroaryl, or cycloalkyl halide or triflate, an amine, thiol, or alcohol in the presence of suitable bases and palladium or copper catalysts known to promote substitutions of boryl groups; and
(d) evaporating the solvent and portions of the reaction mixture which are volatile from the reaction mixture to produce the compound (X-XII).

8. The process of claim 7 wherein R₁ is tert-butoxycarbonyl.

9. The process of claim 1, 3, 5, 7 or 8 wherein the complex is an iridium complex of [Ir(OMe)(COD)]₂, [Ir(Cl)(COD)]₂, or (COD) (η⁵-indenyl) Ir, where COD is 1,5-cyclooctadine, complexed with a ligand selected from the group consisting of: 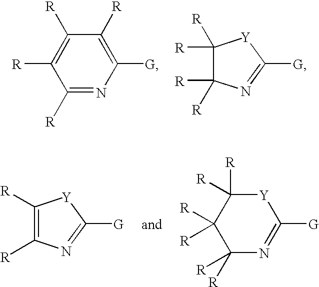
wherein R are each selected from the group consisting of hydrogen, linear alkyl containing 1 to 8 carbon atoms, branched alkyl containing 1 to 8 carbons, and a carbon in a cyclic structure, Y is a carbon, oxygen, nitrogen, or sulfur containing moiety, and G is a heteroatom containing group, multiple atom chain, or multiple atom ring.

10. The process of claim 1, 3, 5, 7 or 8 wherein the complex is an iridium complex of [Ir(OMe)(COD)]₂, [Ir(Cl)(COD)]₂, or (COD) (η⁵-indenyl)Ir, where COD is 1,5-cyclooctadine, complexed with a ligand selected from the group consisting of: 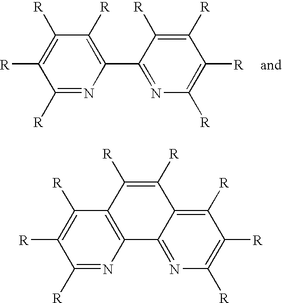
wherein R are each selected from the group consisting of hydrogen, linear alkyl containing 1 to 8 carbon atoms, branched alkyl containing 1 to 8 carbons, and a carbon in a cyclic structure.

11. The process of claim 1, 3, 5, 7 or 8 wherein the complex is an iridium complex of [Ir(OMe)(COD)]₂, [Ir(Cl)(COD)]₂, or (COD) (η⁵-indenyl) Ir, where COD is 1,5-cyclooctadine, complexed with a ligand selected from the group consisting of: 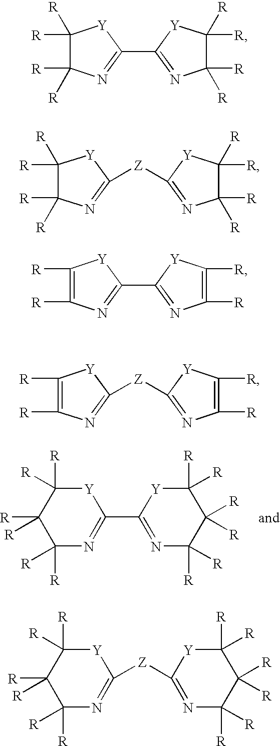
wherein R are each selected from the group consisting of hydrogen, linear alkyl containing 1 to 8 carbon atoms, branched alkyl containing 1 to 8 carbons, and a carbon in a cyclic structure, Y is a carbon, oxygen, nitrogen, or sulfur containing moiety, and Z is a carbon, oxygen, nitrogen, sulfur, or boron containing moiety or a multiple atom chain containing a carbon, oxygen, nitrogen, sulfur, or boron containing moiety.

12. The process of claim 1, 3, 5, 7 or 8 wherein the complex is an iridium complex of [Ir(OMe)(COD)]₂, [Ir(Cl)(COD)]₂, or (COD) (η⁵-indenyl)Ir, where COD is 1,5-cyclooctadine, complexed with a ligand selected from the group consisting of: 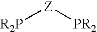
wherein R are each selected from the group consisting of hydrogen, aryl, linear alkyl containing 1 to 8 carbon atoms, branched alkyl containing 1 to 8 carbons, alkoxy, or a carbon in a cyclic structure and Z is a carbon, oxygen, or nitrogen containing moiety or a multiple atom chain containing a carbon, oxygen, or nitrogen containing moiety.

13. The process of claim 1, 3, 5, 7 or 8 wherein the HB or B—B organic compound is HBPin or B₂Pin₂.

14. The process of claims 1, 3, 5, 7 or 8 wherein the complex is an iridium complex of [Ir(OMe)(COD)]₂, [Ir(Cl)(COD)]₂, or (COD) (η⁵-indenyl) Ir, where COD is 1,5-cyclooctadine, complexed with 4,4-di-t-butyl-2,2′bipyridine (dtbpy).

15. The process of claims 1, 3, 5, 7 or 8 wherein the complex is an iridium complex of [Ir(OMe)(COD)]₂, [Ir(Cl)(COD)]₂, or (COD) (η⁵-indenyl)Ir, where COD is 1,5-cyclooctadine, complexed with 1,2-bis(dimethylphospino)ethane.
